(19) United States
(12) Patent Application Publication
(10) Pub. No.: US 2014/0314400 A1
(43) Pub. Date: Oct. 23, 2014

(54) MULTI-LAYER LINK MANAGEMENT DEVICE, MULTI-LAYER INTEGRATED NETWORK TRANSPORT SYSTEM, AND MULTI-LAYER LINK MANAGEMENT METHOD

(71) Applicant: Electronics and Telecommunications Research Institute, Daejeon-si (KR)

(72) Inventor: Won-Kyoung LEE, Daejeon-si (KR)

(73) Assignee: Electronics and Telecommunications Research Institute, Daejeon-si (KR)

(21) Appl. No.: 14/164,999

(22) Filed: Jan. 27, 2014

(30) Foreign Application Priority Data
Apr. 18, 2013 (KR) 10-2013-0043178

(51) Int. Cl. H04L 12/703; H04B 10/03

(52) U.S. Cl. CPC H04L 45/28; H04B 10/03
USPC 398/1; 370/225

(57) ABSTRACT

A multi-layer link management device, a multi-layer integrated network transport system, and a multi-layer link management method are provided. The multi-layer link management device according to an embodiment of the present invention establishes a traffic engineering link stack integrated into one control plane in a multi-layer network, performs real-time monitoring and integrative management on link failure and performance for each layer, and notifies a neighbor node of failure and performance degradation states of a multi-layer link and integratedly manages the failure and performance degradation states. Thus, it is possible to enhance reliability of a multi-layer network and monitor failure and performance degradation in real time, thereby allowing quick performance diagnosis and management of a system and shortening a path protection switching time.

### CROSS-REFERENCE TO RELATED APPLICATION

This application claims the benefit under 35 U.S.C. §119(a) of Korean Patent Application No. 10-2013-0043178, filed on Apr. 18, 2013, the entire disclosure of which is incorporated herein by reference for all purposes.

### BACKGROUND

1. Field

The following description relates to transmission network management technology, and more particularly, to Generalized Multiprotocol Label Switching (hereinafter, referred to as GMPLS) based link management technology.

2. Description of the Related Art

In a data plane, there exist a variety of switching layers such as an optical transport layer, a time division multiplexing (TDM) layer, an Ethernet packet layer, an IP packet layer, etc. Recently, integration of the variety of switching layers is made in the data plane. Accordingly, a technology in which one GMPLS control plane simultaneously controls a variety of switching layers in a multi-layer environment is very important in terms of efficiency. In particular, the technology can reduce complexity in terms of operation and allow efficient network resource management and quick service provisioning.

Failure detection function in the multi-layer link is an essential function for integratedly managing a multi-layer path. Furthermore, a real-time multi-layer link management function for monitoring performance of the multi-layer link in real time to exchange information with a neighbor node is important for multi-layer network reliability, system performance management, and quick path protection switching.

### SUMMARY

The following description relates to a multi-layer link management device, a multi-layer integrated network transport system, and a multi-layer link management method for real-time monitoring and integratedly managing performance of a multi-layer link in a multi-layer network.

In one general aspect, a multi-layer link management device includes a first layer link stack configured to group data links of a first layer into a traffic engineering link of the first layer, a second layer link stack configured to group data links of a second layer into a traffic engineering link of the second layer, and a traffic engineering link stack configured to group the first layer link stack and the second layer link stack into one traffic engineering link to integratedly manage multiple layers including the first layer and the second layer, the integrative management being performed by monitoring link failure and performance degradation for each layer in real time.

The data link of each layer may store a failure parameter and a performance parameter.

The first layer may be a packet transport layer, the failure parameter of the first layer data link may include Tx/Rx port state information, and the performance parameter of the first layer data link may include at least one of Tx/Rx packet statistics information, sequence error information, and control frame information. The traffic engineering link stack may monitor the failure parameter and performance parameter of the first layer data link in real time, determine failure of a packet transport link using the Tx/Rx port state information of the first layer data link, determine performance degradation of the packet transport link using the number of normal packets through the Tx/Rx packet statistics information, and determine performance degradation of the packet transport link and predict failure using the number of pause frames of the control frame information and the sequence error information.

The second layer may be an optical transport layer, the failure parameter of the second layer data link may be an optical loss signal, and the performance parameter of the second layer data link may include at least one of an optical signal to noise ratio and an optical signal level quality factor. The traffic engineering link stack may monitor the failure parameter and performance parameter of the second layer data link in real time, determine failure of an optical transport layer link using an optical loss signal of the second layer data link, and determine performance degradation of the optical transport layer link using an optical signal to noise ratio or optical signal level quality factor.

The data link of each layer may store state information about the data link of each layer including a performance degradation state, and the traffic engineering link of each layer may store state information about the traffic engineering link of each layer including a performance degradation state.

The traffic engineering link of each layer may transmit, to a neighbor node, a link summary message including an object including a property of each traffic engineering link and an object including a property of a data link connected to each traffic engineering link and receive the link summary message from the neighbor node to make the property of the link identical to that of the neighbor node.

The traffic engineering link stack may be converted to a test state if a control channel is in normal operation and the data link of each layer is allocated to the traffic engineering link of each layer, converted to an initial state if the traffic engineering link of each layer is in normal operation in the test state, and converted to a normal state for making multi-layer integrated traffic link information identical to that of the neighbor node by exchanging a link summary message and a link summary acknowledge message with the neighbor node for each layer in the initial state.

The traffic engineering link stack may transmit, to the neighbor node, the channel state message including failure parameter and performance parameter information of each layer in addition to channel state information according to link state variation of each layer to notify the neighbor node of link failure and performance degradation states. The channel state information may include a normal state, a failure state, and a performance degradation state.

In another general aspect, a multi-layer integrated network transport system includes at least one network transport device configured to process mutually different layers at one node, a system OAM (Operation, Administration, and Maintenance) manager configured to receive link state information including a parameter indicating link failure and performance degradation for each layer from the at least one network transport device to integrate data link state information of each layer, and a multi-layer link management device configured to monitor link failure and performance degradation of each layer in real time, acquire link state information of each layer and integrated traffic engineering link information from the system OAM manager, detect the failure and performance degradation, and integratedly manage multiple layer links.

The network transport device may include a packet transport layer line card configured to transmit, to the system OAM manager, a performance parameter including at least one of Tx/Rx packet statistics information, sequence error information, and control frame information indicating performance of a packet transport link and a failure parameter including Tx/Rx port state information indicating failure of the packet transport link.

The network transport device may include an optical transport layer sub-system configured to transmit, to the system OAM manager, a performance parameter including at least one of an optical signal to noise ratio and an optical signal level quality factor indicating performance of an optical transport layer link and a failure parameter including an optical loss signal indicating failure of the optical transport layer link.

The multi-layer link management device may monitor link failure and performance degradation for each layer in real time and transmit, to a neighbor node, a channel state message including the failure parameter and performance parameter information of each layer in addition to channel state information according to link state variation of each layer to notify the neighbor node of the link failure and performance degradation.

In still another general aspect, a multi-layer link management method includes monitoring a link state of each layer in a multi-layer network in real time, acquiring link state information of each layer and integrated traffic engineering link information through the real-time monitoring to detect link failure and performance degradation of each layer, and defining correlation between layers to integratedly manage the link failure and performance degradation of each layer using the defined correlation.

The detecting of the link failure and performance degradation may include at least one of determining failure of a packet transport link using Tx/Rx port state information of a packet transport layer data link as a failure parameter through real-time monitoring of the failure parameter and a performance parameter of the packet transport layer data link, determining performance degradation of the packet transport link using the number of normal packets included in the Tx/Rx packet statistics information which is the performance parameter, and determining performance degradation of the packet transport link and predicting failure using the number of pause frames of the control frame information and the sequence error information which are the performance parameters.

The detecting the link failure and performance degradation may include at least one of determining failure of an optical transport layer link using an optical loss signal of an optical transport layer data link which is the failure parameter, through real-time monitoring of the failure parameter and performance parameter of the optical transport layer data link, and determining performance degradation of the optical transport layer link using the optical signal to noise ratio or the quality factor of the optical signal level which is the performance parameter.

The multi-layer link management method may further include notifying a neighbor node of link failure and performance degradation of each layer in which the notifying of the neighbor node of link failure and performance degradation is performed by transmitting, to the neighbor node, a channel state message including the failure parameter and performance parameter of each layer in addition to channel state information according to link state change of each layer.

Other features and aspects will be apparent from the following detailed description, the drawings, and the claims.

### BRIEF DESCRIPTION OF THE DRAWINGS

FIG. 1 is a block diagram showing a relation between GMPLS protocols according to an embodiment of the present invention.

FIG. 2 is a block diagram showing a multi-layer link management device according to an embodiment of the present invention.

FIG. 3 is a reference view showing a correlation between data blocks forming an integrated traffic engineering (TE) link according to an embodiment of the present invention.

FIGS. 4A and 4B are finite state machine (FSM) state diagrams of a data link in consideration of link performance according to an embodiment of the present invention.

FIG. 5 is an FSM state diagram of a TE link according to an embodiment of the present invention.

FIG. 6 is an FSM state diagram of a TE link stack according to an embodiment of the present invention.

FIG. 7 is a flowchart showing a process of exchanging a link summary message for attribute correlation of the integrated TE link in a multi-layer network according to an embodiment of the present invention.

FIG. 8 is a block diagram of an integrated network transport system for monitoring failure and performance of a multi-layer link according to an embodiment of the present invention.

FIG. 9 is a detailed block diagram of a network transport device of a multi-layer integrated network transport system of FIG. 8 according to an embodiment of the present invention.

FIG. 10 is a flowchart showing a process of exchanging a channel state message between neighbor nodes when link failure and performance degradation occur according to an embodiment of the present invention.

FIG. 11 is a structure diagram of the channel state message of FIG. 10 according to an embodiment of the present invention.

FIG. 12 is a sub-object structure diagram including a performance parameter for managing the multi-layer link performance of FIG. 11 according to an embodiment of the present invention.

FIG. 13 is a flowchart showing a multi-layer link management method according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, embodiments of the present invention will be described in detail with reference to the accompanying drawings. In the following description, when the detailed description of the relevant known function or configuration is determined to unnecessarily obscure the important point of the present invention, the detailed description will be omitted. Also, the terms described below are defined in consideration of the functions in the present invention, and thus may vary depending on intention of a user or an operator, or custom. Accordingly, the definition would be made on the basis of the whole specification.

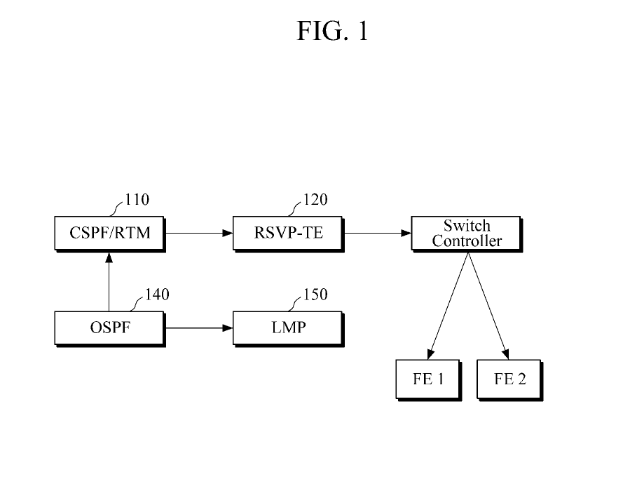

FIG. 1 is a block diagram showing a relation between Generalized Multiprotocol Label Switching (hereinafter, referred to as GMPLS) protocols according to an embodiment of the present invention.

Referring to FIG. 1, the present invention is a technology for monitoring and integratedly managing link failure and performance of a multi-layer within one domain using only one GMPLS control plane. Here, the “multi-layer” has a concept of “cross”, which refers not to a horizontal concept layer structure for controlling multiple domains, but to a vertical concept layer structure for controlling a variety of layers in a single domain. Hereinafter, the relation between GMPLS protocols of the present invention will be described.

Resource Reservation Protocol-Traffic Engineering (RSVP-TE) 120 is a signaling protocol for setting a path. Constrained Shortest Path First/route table manager (CSPF/RTM) 110 is a protocol for generating a network topology and calculating a path. A path in a multi-layer network is calculated by applying different parameters and importance to each layer. That is, for each layer, a weighted graph is drawn to reflect different traffic engineering (TE) metrics or link costs, or different constraints, and then an optimal multi-layer path is selected using the shortest path algorithm.

Information needed to generate the network topology in CSPF/RTM 110 is traffic engineering information of a TE link provided by Open Shortest Path First (OSPF) 140. The present invention uses a concept of a TE link stack such that the OSPF 140 may provide integrated TE link information in consideration of a multi-layer network environment.

Link Management Protocol (hereinafter, referred to as LMP) 150 integratedly manages the TE link stack in addition to the link of each layer. The LMP 150 is a protocol for managing a link between neighbor nodes and serves to group several data links into one TE link and to automatically make a physical port of a local node identical to that of a neighbor node Also, the LMP 150 serves to detect failure generated in the data link to notify the neighbor node of the detected failure.

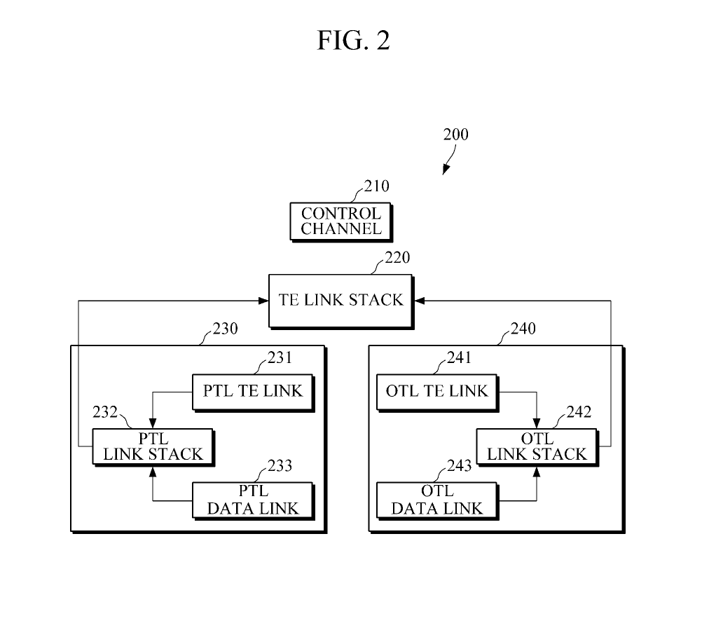

FIG. 2 is a block diagram showing a multi-layer link management device 200 according to an embodiment of the present invention.

Referring to FIG. 2, the multi-layer link management device 200 includes a control channel 210, a TE link stack 220, a packet transport layer 230, and an optical transport layer 240. In order to facilitate an understanding of the present invention, the packet transport layer 230 and the optical transport layer 240 among multiple layers are described in FIG. 2. However, the present invention is not limited thereto.

The control channel 210 is used to exchange LMP information with a neighbor node. The control channel 210 may search for the neighbor node through a config massage and periodically exchange a hello message with the neighbor node to check whether to be connected to the neighbor node.

The packet transport layer 230 includes a packet transport layer traffic engineering link (PTL TE link) 231, a PTL link stack 232, and a PTL data link 233, The PTL link stack 232 groups the PTL TE link 231 for the PTL data link 233 of the packet transport layer 230, independently of the optical transport layer 240.

The optical transport layer 240 includes an OTL TE link 241, an OTL link stack 242, and an OTL data link 243. The OTL link stack 242 groups the OTL TE link 241 for the OTL data link 243 of the optical transport layer 240, independently of the packet transport layer 230.

The TE link stack 220 binds a link stack of the packet transport layer 230 and a link stack of the optical transport layer 240 to group one TE link, which is an abstract link. The TE link is used for easy and quick path calculation. The data link is a link for transporting actual traffic, which corresponds to a component link of the TE link. Accordingly, the TE link stack 220 may establish the network topology only with the GMPLS control plane in the multi-layer network environment using the grouped TE link.

In a general link management protocol, there are a TE link, a data link, and a data block of a link stack, regardless of layers. However, according to the present invention, in order to establish one integrated TE link for calculating a path of the multi-layer network, the link management protocol does not manage link stack information of each layer independently, but the TE link stack 220 defines correlation of the link stack between layers and delivers the defined correlation to a routing protocol.

The TE link stack 220 defines correlation between the layers, using a first TE link ID about a traffic engineering link grouped in correlation with the optical transport layer 240 and a second TE link ID about a traffic engineering link grouped in correlation with the packet transport layer 230, and manages the optical transport layer 240 and the packet transport layer 230 using the defined correlation. Traffic engineering information and link information needed for each layer are stored for each layer, and the TE link stack defines the correlation between two layers. Furthermore, the present invention monitors link performance of each layer to manage both failure and performance of the multi-layer link.

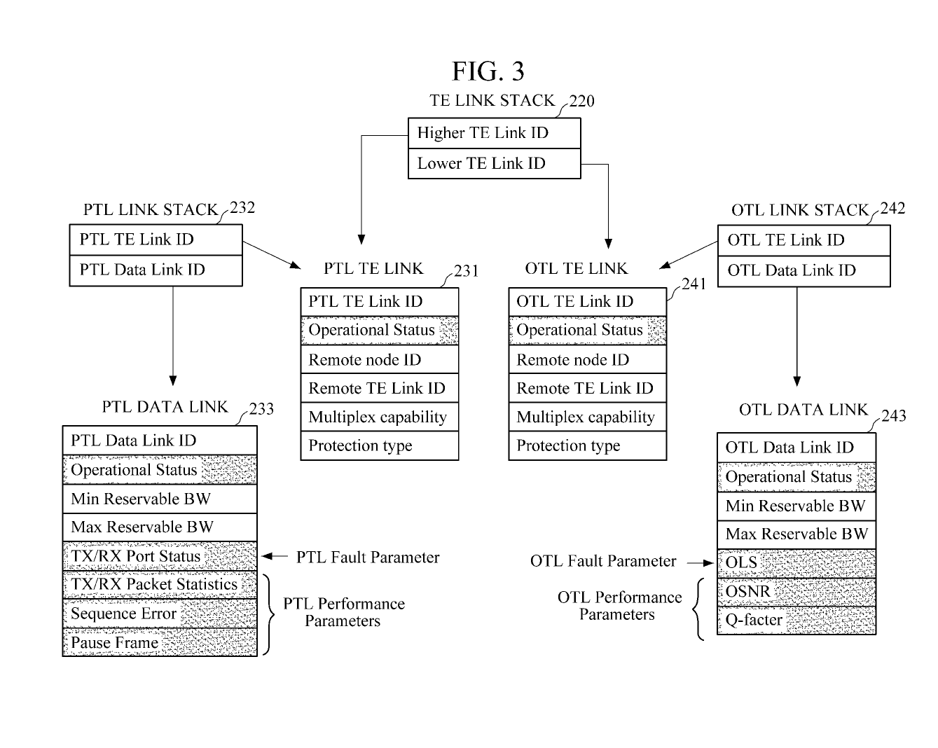

FIG. 3 is a reference view showing a correlation between data blocks forming an integrated TE link according to an embodiment of the present invention.

Referring to FIG. 3, the TE link stack 220 stores a TE link ID of a higher layer (higher TE link ID) and a TE link ID of a lower layer (lower TE link ID) to define the correlation between the layers. The higher layer and the lower layer may be one of the optical transport layer and the packet transport layer.

The PTL link stack 232 may include a PTL TE link ID and a PTL data link ID. The PTL TE link 231 and the PTL data link 233 each store the traffic engineering information and link information which are needed for the packet transport layer. The corresponding information may be stored in the PTL data link 233 in a form of management information base (hereinafter, referred to as MIB).

The OTL link stack 242 may include an OTL TE link ID and an OTL data link ID. The OTL TE link 241 and the OTL data link 243 each store the traffic engineering information and link information which are needed for the optical transport layer. The corresponding information may be stored in the OTL data link 243 in a MIB form.

The TE link stack 220 makes a TE link property identical between the two layers described above. In this case, the TE link stack 220 may communicate multi-layer link information with a neighbor node and reflect multi-layer link state information, which is updated every time, to the network topology.

Meanwhile, according to the present invention, failure and performance parameters of each layer are added to the MIB of the data link of each layer. Hereinafter, the failure and performance parameters of each layer stored in the MIB of the OTL data link 243 and the PTL data link 233 will be described.

According to an embodiment, control frame information such as Tx/Rx port state information, Tx/Rx packet statistics information, sequence error information, and pause frame information is stored in the PTL data link 233. Then, the TE link stack 220 determines failure of the packet transport link using the Tx/Rx port state information of the PTL data link 233. Furthermore, the TE link stack 220 determines performance degradation of the packet transport link using the number of normal packets through the Tx/Rx packet statistics information, and determines performance degradation and predicts failure using the sequence error information and the number of pause frames.

According to an embodiment, a failure parameter including an optical loss signal (OLS) and a performance parameter such as an optical signal to noise ratio (OSNR) indicating a ratio of an optical input signal and a noise signal, an optical signal level quality factor (Q-factor) that is a quality criterion, etc. are stored in the OTL data link 243. The TE link stack 220 determines failure of the optical transport layer link using the optical loss signal of the OTL data link 243 and determines performance degradation of the optical transport layer link using the optical signal to noise ratio or optical signal level quality factor.

In order for the TE link stack 220 to manage the link performance of each layer, a degradation state is added to an operational state of each of the PTL and OTL data links 233 and 243 and the PTL and OTL TE links 231 and 241.

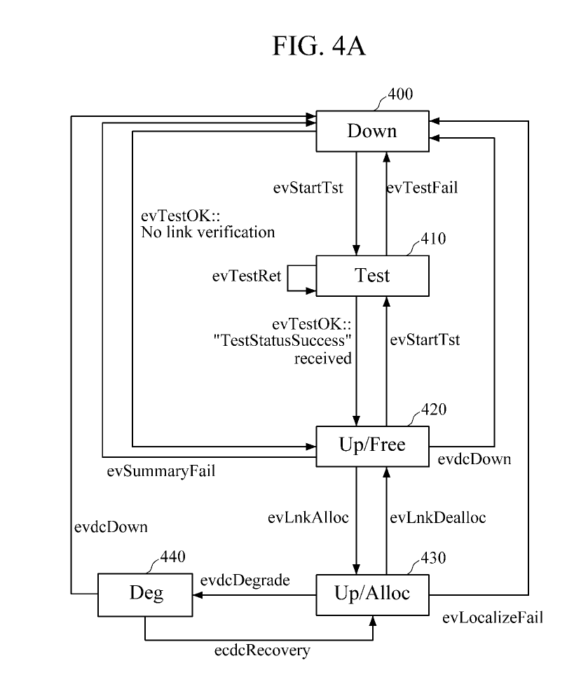

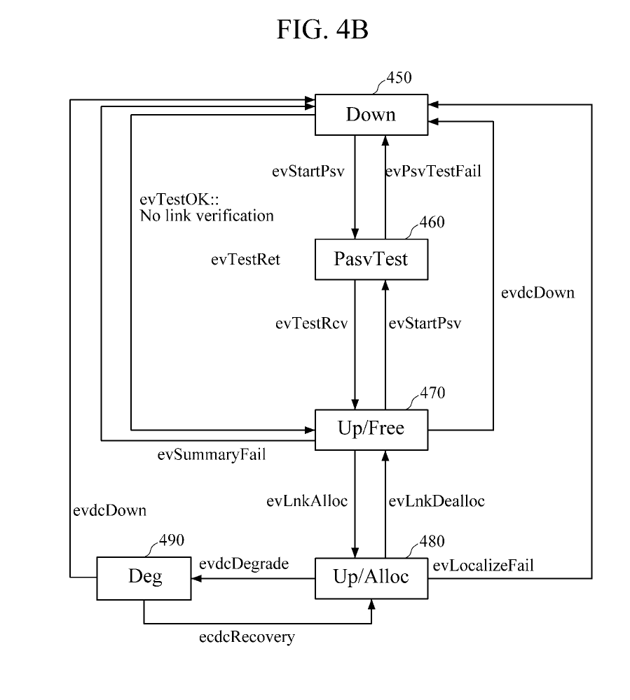

FIGS. 4A and 4B are state diagrams of a finite state machine (hereinafter, referred to as FSM) of a data link in consideration of link performance according to an embodiment of the present invention. Specifically, FIG. 4A is a state diagram of FSM of an active data link, and FIG. 4B is a state diagram of FSM of a passive data link.

Referring to FIGS. 4A and 4B, the data link state in the FSM of the data link in consideration of performance degradation of the multi-layer data link is classified into five states as follows.

(1) Down 400 or 450: a state where the data link is not in service and thus a packet or optical signal cannot be transmitted.

(2) Test 410: a state where a test message is periodically transmitted.
PasvTest 460: a state where a test message is periodically received.

(3) Up/Free 420 or 470: a state where the data link is in service but traffic is not transmitted yet.

(4) Up/Alloc 430 or 480: a state where the data link is in service and traffic is being transmitted.

(5) Deg 440 or 490: a state where the performance of the data link falls below a predetermined threshold.

Meanwhile, events for changing the state of the data link are as follows.

(1) evStartTst: transmit a test message

(2) evStartPsv: wait for a test message

(3) evTestOK: succeed in link verification

(4) evTestRcv: receive a test message and transmit a test state success message (TestStateSuccess)

(5) evTestFail: fail in link verification

(6) evPsvTestFail: fail in link verification

(7) evLinkAlloc: data link is allocated (traffic is transmitted)

(8) evLinkDealloc: data link is not allocated

(9) evTestRet: retransmission time expires, thereby retransmitting the test message

(10) evLocalizeFail: failure is detected

(11) evdcDown: data link is not in service any more

(12) evdcDegraded: one ore more of performance parameters of the data link falls below a predetermined threshold

(13) evdcRecovery: degraded performance parameter of the data link is restored above the threshold

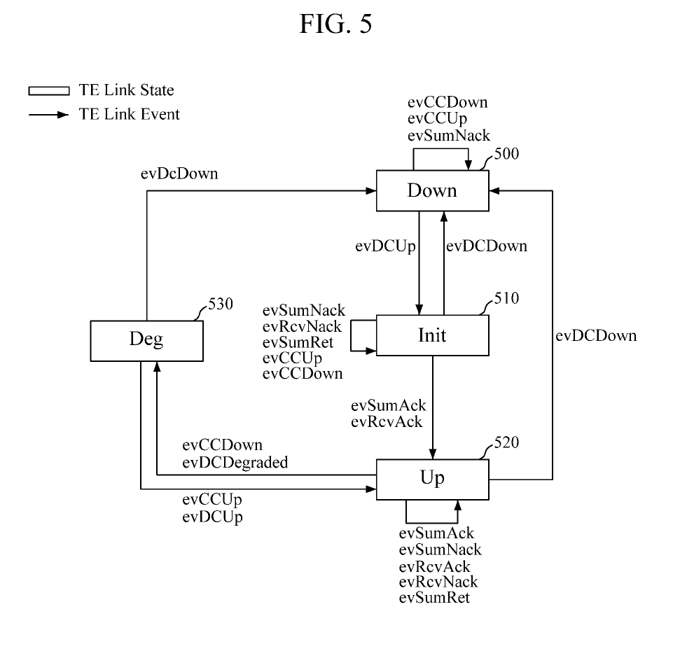

FIG. 5 is an FSM state diagram of a TE link according to an embodiment of the present invention.

Referring to FIG. 5, when the control channel is up and the data link is allocated to the TE link, the TE link becomes an initial state (Init) 510 and periodically transmits a link summary (LinkSummary) message to a neighbor node. The LinkSummary message includes an object including properties of the TE link and an object including properties of the data link. Accordingly, the link property is made identical to that of the neighbor node by exchanging the LinkSummary message and a link summary acknowledge (LinkSummaryAck) message with the neighbor node. If the performance of the data link is degraded, the state of the TE link is converted from an Up state 520 to a performance degradation state (Deg) state 530. If the performance of the data link is restored, the state of the TE link is returned from the Deg state 530 to the Up state 520. When the state of the TE link is converted into the Deg state 530, path calculation may be performed again by a path calculation element for optimal traffic transmission.

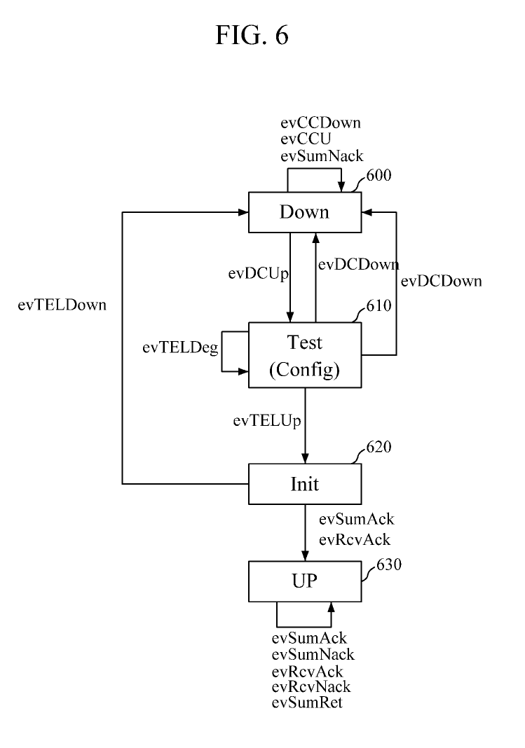

FIG. 6 is an FSM state diagram of a TE link stack according to an embodiment of the present invention.

Referring to FIG. 6, the TE link stack makes TE link properties identical for each layer. The TE link stack may exchange multi-layer link information with a neighbor node through the exchange of the modified LinkSummary message and reflect multi-layer link state information, which is updated every time, to the network topology.

The states of the TE link stack may be largely classified into four types.

(1) Down 600: a state where a data link is not allocated to a TE link.

(2) Test 610: a state where a data link is allocated to a TE link, but the TE link is not up.

(3) Init 620: a state where the TE link of each layer is up, but the multi-layer TE link stack is not identical to that of a neighbor node and periodically transmits a LinkSummary message to the neighbor node.

(4) Up 630: a state where the multi-layer TE link stack receives a LinkSummaryAck acknowledge message from the neighbor node in response to the LinkSummary message to be in normal operation, and periodically transmits the LinkSummary message.

Also, events for changing the state of the TE link stack are as follows.

(1) evDCUp: allocate one or more data links to TE link

(2) evSumAck: receive LinkSummary message to respond positively

(3) evSumNack: receive LinkSummary message to respond negatively

(4) evRcvAck: receive LinkSummaryAck message

(5) evRcvNack: receive LinkSummaryNack message

(6) evSumRet: retransmit LinkSummary message due to expiration of a timer

(7) evCCUp: control channel is up

(8) evCCDown: control channel is down

(9) evDCDown: remove data link allocated to TE link

(10) evTELDeg: TE link state of each layer is degraded

(11) evTELDown: TE link state of each layer is down

(12) evTELUp: TE link state of each layer is up

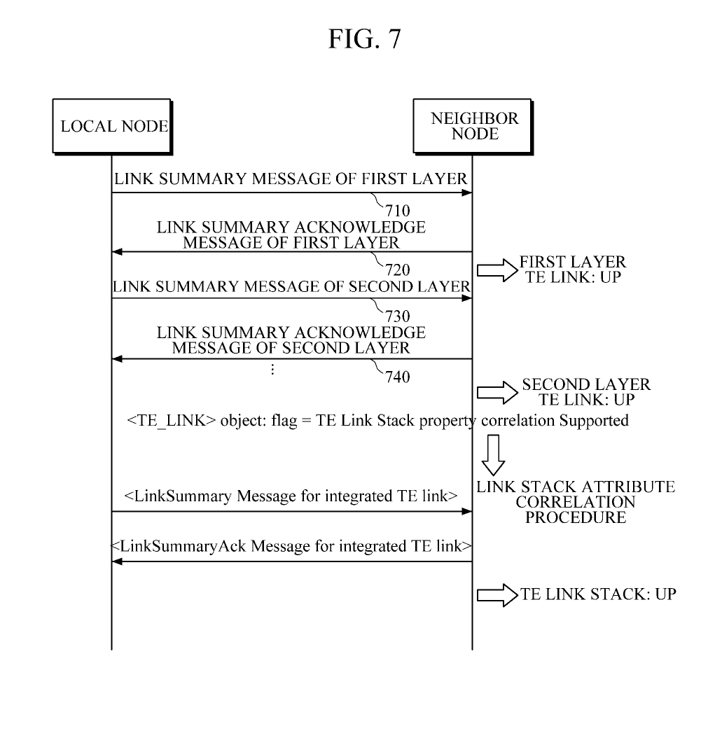

FIG. 7 is a flowchart showing a process of exchanging a link summary message for attribute correlation of the integrated TE link in the multi-layer network according to an embodiment of the present invention.

Referring to FIGS. 6 and 7, when the control channel is up and the data link of each layer is allocated to the TE link, the TE link stack becomes the Test state 610. The Test state 610 is a state where a data link is allocated to a TE link, but the TE link is not up. When the TE link of each layer is up in the Test state 610, the TE link stack is converted to the Init state 620. The Init state 620 is a state where the TE link of each layer is up, but the multi-layer TE link stack is not the identical to that of a neighbor node.

In the Init state 620, as shown in FIG. 7, when a link summary (LinkSummary) message and a link summary acknowledge (LinkSummaryAck) message are exchanged with the neighbor node for each layer 710, 720, 730, or 740, the TE link stack of each layer becomes the Up state 630. When the TE link stack becomes the Up state 630, the multi-layer integrated TE link information is made identical between the local node and the neighbor node. Subsequently, the local node delivers the integrated TE link information of the neighbor node and the local node to the OSPF, the OSPF provides the TE link information of each layer and integrated TE link information to the CSPF, and then the CSPF establishes a topology for the multi-layer network to calculate a multi-layer path.

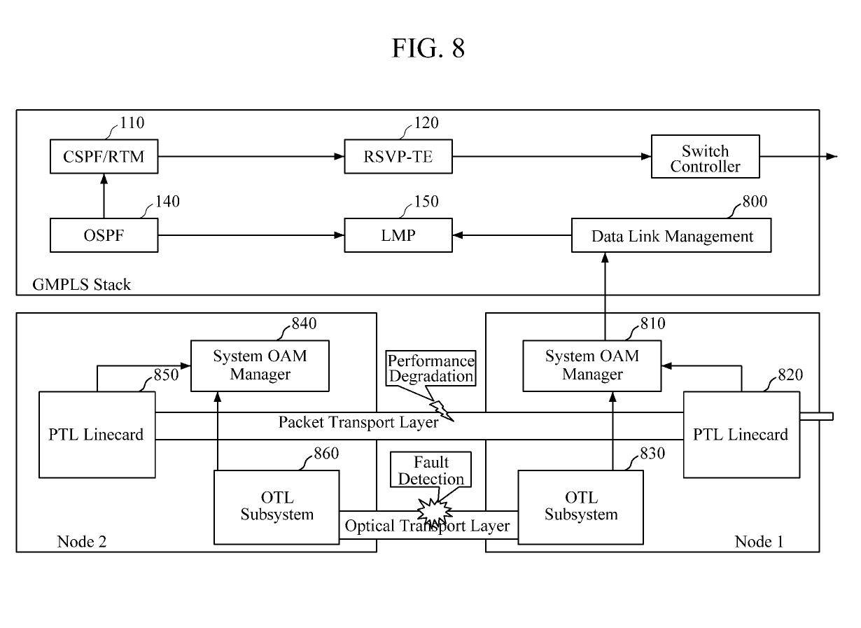

FIG. 8 is a block diagram of an integrated network transport system for monitoring failure and performance of a multi-layer link according to an embodiment of the present invention.

Referring to FIG. 8, a data link management block 800, which is a sub-block of the LMP 150 that is a protocol for managing a link in the GMPLS stack, monitors a link state of each layer in real time, and when detecting failure and performance degradation, notifies the failure and performance degradation to the LMP 150. A system OAM (Operation, Administration, and Maintenance) manager 810 or 840 of each node integrates the data link state information of each layer to deliver the integrated data link state information to the data link management block 800 in the GMPLS stack. Since the system OAM manager 810 or 840 integratedly manages link information of an OTL sub-system 830 or 860 and a PLT line card 820 or 850 that is a network transfer device, the data link management block 800 does not need to communicate with all the PLT line cards 820 and 850 and OTL sub-systems 830 and 860, thereby reducing the amount of control traffic. Each of the OTL sub-systems 830 and 860 may be a wavelength division multiplexer (WDM), a dence wavelength division multiplexer (DWDM), and a reconfigurable optical add-drop multiplexer (ROADM).

The OSPF 140 receives TE link information of each layer and integrated TE link information from the LMP 150, and the CSPF/RTM 110 receives the TE link information of each layer and the integrated TE link information from the OSPF 140 and establishes a topology for the multi-layer network to calculate a multi-layer path.

Functions of the CSPF/RTM 110 and the OSPF 140 may be performed in a router or dedicated device in hardware, and serve to determine a shortest path and calculate a multi-layer path on the basis of the determined shortest path.

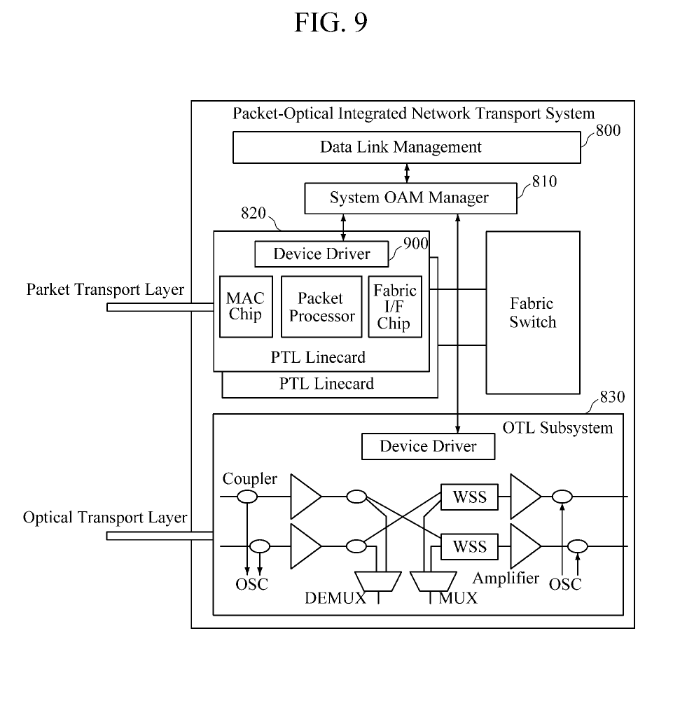

FIG. 9 is a detailed block diagram of a network transport device of a multi-layer integrated network transport system of FIG. 8 according to an embodiment of the present invention.

Referring to FIGS. 8 and 9, in a multi-layer network including two layers, a packet transport layer (Ethernet or IP) and an optical layer (lambda and fiber), the network transport device includes a PTL line card 820 responsible for packet transmission and an OTL sub-system 830 responsible for optical signal transmission.

A device driver 900 of the PTL line card 820 delivers, to the system OAM manager 810, information including a Tx/Rx port state, the number of normal packets, a sequence error, the number of pause frames, which indicate performance of a PTL link. The OTL sub-system 830 delivers, to the system OAM manager 810, information such as LOS signal, OSNR, and Q-factor, which indicate performance of an OTL link.

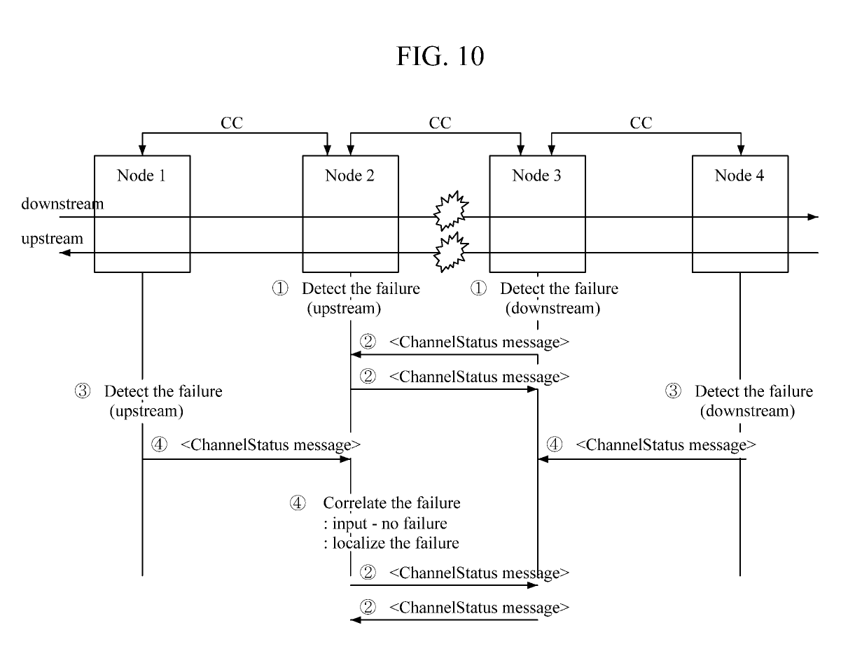

FIG. 10 is a flowchart showing a process of exchanging a channel state (ChannelState) message between neighbor nodes when link failure and performance degradation occur according to an embodiment of the present invention.

Referring to FIG. 10, the LMP notifies a neighbor node of variation in a data link state of each layer, using the ChannelState message. For example, as shown in FIG. 10, when Node 2 detects failure of an upstream transport link and Node 3 detects failure of a downstream transport link (\textcircled{1}), Node 2 and Node 3 exchange the ChannelState messages (\textcircled{2}). Subsequently, when Node 1 detects failure of an upstream link and Node 4 detects failure of a downstream link (\textcircled{3}), Node 1 delivers the ChannelState message to Node 2 and Node 4 delivers the ChannelState message to Node 3 to correlate failure information between nodes (\textcircled{4}), and Node 2 and Node 3 exchange the ChannelState messages (\textcircled{2}).

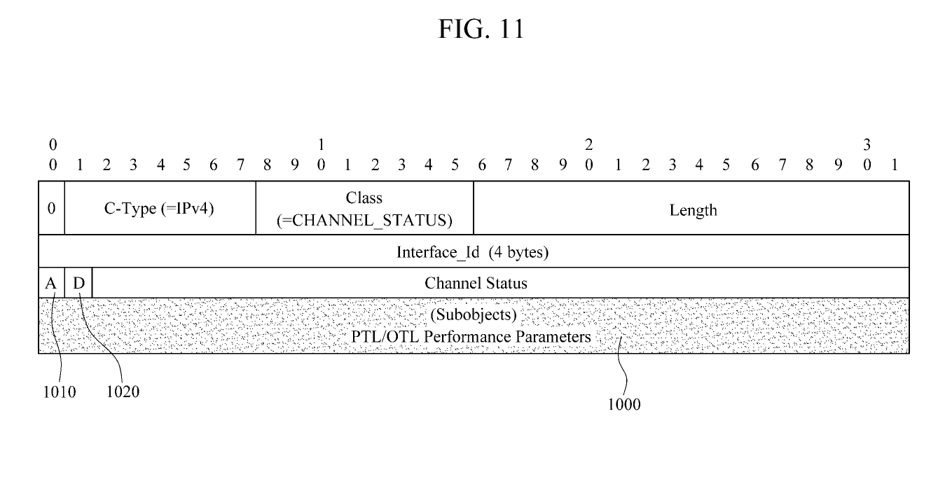

FIG. 11 is a structure diagram of the ChannelState message of FIG. 10 according to an embodiment of the present invention.

Referring to FIGS. 10 and 11, in order to notify a neighbor node of performance degradation of the data link in addition to failure of the data link, a sub-object 1000 including performance parameter information of each layer is added to <CHANNEL_STATE> object.

<ChannelState Message>::=<Common Header><LOCAL_LINK_ID>
<MESSAGE_ID><CHANNEL_STATE>

Bit “A” 1010 of the ChannelState message is an active bit, which indicates whether allocation is performed on traffic or not. Bit “D” 1020 is a direction bit, which indicates a Tx/Rx direction. A channel state field indicates state information of the data link, which includes OK (normality), SD (performance degradation), and SF (failure) information.

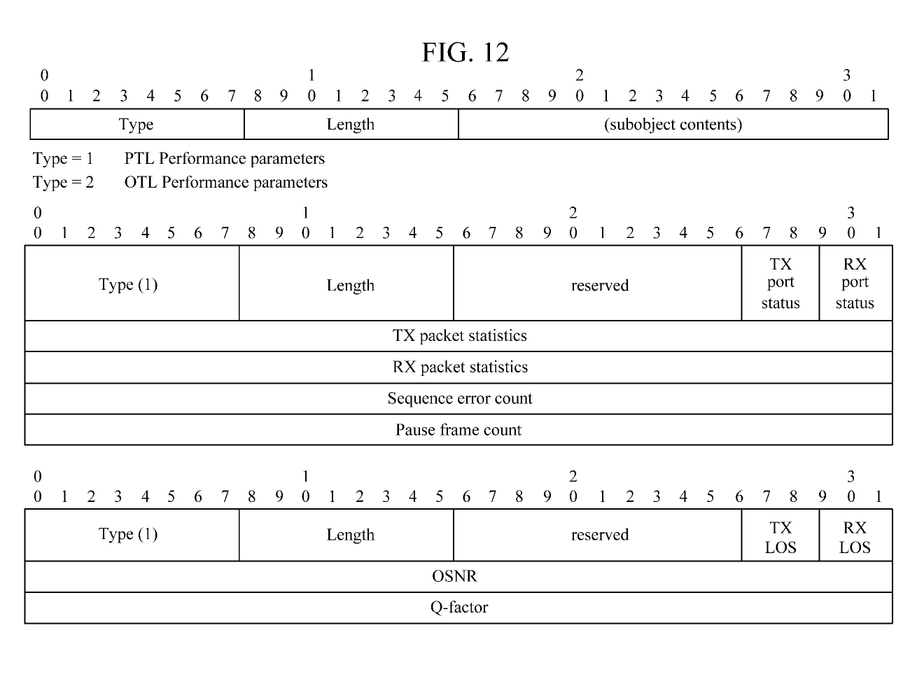

FIG. 12 is a sub-object structure diagram including a performance parameter for managing the multi-layer link performance of FIG. 11 according to an embodiment of the present invention.

Referring to FIGS. 11 and 12, if the state of the data link is SD, a sub-object of OTL/PTL performance parameters is added to the ChannelState message. A structure of the sub-object of the OTL/PTL performance parameters is shown in FIG. 12. That is, the sub-object may include Tx/Rx packet statistics information, sequence error count information, and pause frame count information which are performance parameters of a packet transport layer data link and an optical signal to noise ratio and an optical signal level quality factor which are performance parameters of an optical transport layer data link.

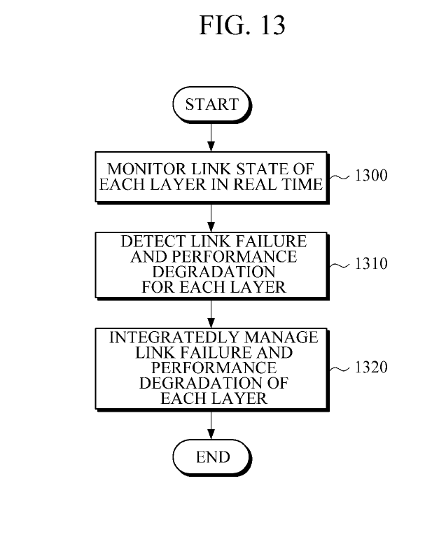

FIG. 13 is a flowchart showing a multi-layer link management method according to an embodiment of the present invention.

Referring to FIG. 13, a multi-layer link management device monitors a link state of each layer in a multi-layer network in real time in operation 1300. Also, the multi-layer link management device acquires link state information of each layer and integrated traffic engineering link information through real-time monitoring to detect link failure and performance degradation for each layer in operation 1310.

In operation 1310, the multi-layer link management device may determine failure of a packet transport link using the Tx/Rx port state information of the packet transport layer data link. Furthermore, the multi-layer link management device may determine performance degradation of the packet transport link using the number of normal packets through Tx/Rx packet statistics information, and may determine performance degradation of the packet transport link and predict failure using the number of pause frames of control frame information and sequence error information.

In operation 1310, the multi-layer link management device may determine failure of an optical transport layer link using an optical loss signal of the optical transport layer data link. Also, the multi-layer link management device may determine performance degradation of the optical transport layer link using an optical signal to noise ratio or optical signal level quality factor.

The multi-layer link management device defines correlation between layers and integratedly manages failure and performance degradation of each layer using the defined correlation in operation 1320.

The multi-layer link management device notifies a neighbor node of link failure and performance degradation of each layer according to an embodiment. In this case, the multi-layer link management device can transmit, to the neighbor node, the channel state message including failure parameter and performance parameter information of each layer in addition to channel state information according to link state variation of each layer to notify the neighbor node of link failure and performance degradation states.

According to an embodiment, it is possible to establish a traffic engineering link integrated into one control plane in the multi-layer network and perform real-time monitoring and integrative management on link failure and performance of each layer, thereby enhancing reliability of the multi-layer network.

Moreover, by real-time monitoring failure and performance parameters of data links mutually different for each layer, notifying a neighbor node of failure and performance degradation states of the multi-layer link, and integratedly managing the failure and performance degradation states, it is possible to monitor failure and performance degradation in real time, thereby quickly performing system performance diagnosis and management and shortening a path protection switching time.

This invention has been particularly shown and described with reference to preferred embodiments thereof. It will be understood by those skilled in the art that various changes in form and details may be made therein without departing from the spirit and scope of the invention as defined by the appended claims. Accordingly, the referred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A multi-layer link management device comprising:
a first layer link stack configured to group data links of a first layer into a traffic engineering link of the first layer;
a second layer link stack configured to group data links of a second layer into a traffic engineering link of the second layer; and
a traffic engineering link stack configured to group the first layer link stack and the second layer link stack into one traffic engineering link to integratedly manage multiple layers including the first layer and the second layer, the integrated management being performed by monitoring link failure and performance degradation for each layer in real time.

2. The multi-layer link management device of claim 1, wherein the data link of each layer stores a failure parameter and a performance parameter.

3. The multi-layer link management device of claim 2, wherein the first layer is a packet transport layer, and
the failure parameter of the first layer data link includes Tx/Rx port state information, and the performance parameter of the first layer data link includes at least one of Tx/Rx packet statistics information, sequence error information, and control frame information.

4. The multi-layer link management device of claim 3, wherein the traffic engineering link stack monitors the failure parameter and performance parameter of the first layer data link in real time, determines failure of a packet transport link using the Tx/Rx port state information of the first layer data link, determines performance degradation of the packet transport link using the number of normal packets through the Tx/Rx packet statistics information, and determines performance degradation of the packet transport link and predicts failure using the number of pause frames of the control frame information and the sequence error information.

5. The multi-layer link management device of claim 2, wherein the second layer is an optical transport layer, and
the failure parameter of the second layer data link is an optical loss signal, and the performance parameter of the second layer data link includes at least one of an optical signal to noise ratio and an optical signal level quality factor.

6. The multi-layer link management device of claim 5, wherein the traffic engineering link stack monitors the failure parameter and performance parameter of the second layer data link in real time, determines failure of an optical transport layer link using an optical loss signal of the second layer data link, and determines performance degradation of the optical transport layer link using an optical signal to noise ratio or optical signal level quality factor.

7. The multi-layer link management device of claim 1, wherein the data link of each layer stores state information about the data link of each layer including a performance degradation state, and the traffic engineering link of each layer stores state information about the traffic engineering link of each layer including a performance degradation state.

8. The multi-layer link management device of claim 1, wherein the traffic engineering link of each layer transmits, to a neighbor node, a link summary message including an object including a property of each traffic engineering link and an object including a property of a data link connected to each traffic engineering link, and receives the link summary acknowledge message from the neighbor node to make the property of the link identical to that of the neighbor node.

9. The multi-layer link management device of claim 1, wherein the traffic engineering link stack is converted to a test state if a control channel is in normal operation and the data link of each layer is allocated to the traffic engineering link of each layer, converted to an initial state if the traffic engineering link of each layer is in normal operation in the test state, and converted to a normal state for making multi-layer integrated traffic link information identical to that of the neighbor node by exchanging a link summary message and a link summary acknowledge message with the neighbor node for each layer in the initial state.

10. The multi-layer link management device of claim 1, wherein the traffic engineering link stack transmits, to the neighbor node, a channel state message including the failure parameter and performance parameter information of each layer in addition to the channel state information according to link state conversion of each layer to notify the neighbor node of the link failure and performance degradation states.

11. The multi-layer link management device of claim 10, wherein the channel state information includes a normal state, a failure state, and a performance degradation state.

12. A multi-layer integrated network transport system comprising:
at least one network transport device configured to process mutually different layers at one node;
a system OAM (Operation, Administration, and Maintenance) manager configured to receive link state information including a parameter indicating link failure and performance degradation for each layer from the at least one network transport device to integrate data link state information of each layer; and
a multi-layer link management device configured to monitor link failure and performance degradation of each layer in real time, acquire link state information of each layer and integrated traffic engineering link information from the system OAM manager, detect the failure and performance degradation, and integratedly manage multiple layer links.

13. The multi-layer integrated network transport system of claim 12, wherein the network transport device comprises a packet transport layer line card configured to transmit, to the system OAM manager, a performance parameter including at least one of Tx/Rx packet statistics information, sequence error information, and control frame information indicating performance of a packet transport link and a failure parameter including Tx/Rx port state information indicating failure of the packet transport link.

14. The multi-layer integrated network transport system of claim 12, wherein the network transport device comprises an optical transport layer sub-system configured to transmit, to the system OAM manager, a performance parameter including at least one of an optical signal to noise ratio and an optical signal level quality factor indicating performance of an optical transport layer link and a failure parameter including an optical loss signal indicating failure of the optical transport layer link.

15. The multi-layer integrated network transport system of claim 12, wherein the multi-layer link management device monitors link failure and performance degradation for each layer in real time and transmits, to a neighbor node, a channel state message including the failure parameter and performance parameter information of each layer in addition to channel state information according to link state variation of each layer to notify the neighbor node of the link failure and performance degradation.

16. A multi-layer link management method comprising:
monitoring a link state of each layer in a multi-layer network in real time;
acquiring link state information of each layer and integrated traffic engineering link information through the real-time monitoring to detect link failure and performance degradation of each layer; and
defining correlation between layers to integratedly manage the link failure and performance degradation of each layer using the defined correlation.

17. The multi-layer link management method of claim 16, wherein the detecting of the link failure and performance degradation comprises at least one of:
determining failure of a packet transport link using Tx/Rx port state information of a packet transport layer data link as a failure parameter through real-time monitoring of the failure parameter and a performance parameter of the packet transport layer data link;
determining performance degradation of the packet transport link using the number of normal packets included in the Tx/Rx packet statistics information which is the performance parameter; and
determining performance degradation of the packet transport link and predicting failure using the number of pause frames of the control frame information and the sequence error information which are the performance parameters.

18. The multi-layer link management method of claim 16, wherein the detecting of the link failure and performance degradation comprises at least one of:
determining failure of an optical transport layer link using an optical loss signal of an optical transport layer data link which is the failure parameter, through real-time monitoring of the failure parameter and performance parameter of the optical transport layer data link; and
determining performance degradation of the optical transport layer link using the optical signal to noise ratio or optical signal level quality factor which is the performance parameter.

19. The multi-layer link management method of claim 16, further comprising notifying a neighbor node of link failure and performance degradation of each layer.

20. The multi-layer link management method of claim 19, wherein the notifying of the neighbor node of link failure and performance degradation comprises notifying the neighbor node of link failure and performance degradation by transmitting, to the neighbor node, a channel state message including the failure parameter and performance parameter of each layer in addition to channel state information according to link state change of each layer.
